(19) United States
(12) Patent Application Publication
(10) Pub. No.: US 2025/0098581 A1
(43) Pub. Date: Mar. 27, 2025

(54) Agricultural Implement Monitoring

(71) Applicant: AGCO International GmbH, Neuhausen (CH)

(72) Inventors: Martin Peter Christiansen, Randers (DK); Esma Mujkic, Randers (DK); Ramon Buchaca Tarragona, Randers (DK); Morten Stigaard Laursen, Randers (DK); Kenneth Düring Jensen, Randers (DK)

(21) Appl. No.: 18/291,814

(22) PCT Filed: Sep. 12, 2022
(86) PCT No.: PCT/IB2022/058559

§ 371 Date: Jan. 24, 2024

(30) Foreign Application Priority Data
Sep. 21, 2021 (GB) 2113422.6

(51) Int. Cl. A01D 41/127

(52) U.S. Cl. CPC A01D 41/127

(57) ABSTRACT

Systems and methods are provided for monitoring the operation of an implement associated with an agricultural machine. An imaging sensor may be used having an imaging region at least partly covering the implement, along with a thermal sensor having a sensing region which at least partly coincides with the imaging region of the imaging sensor. The image data from the imaging sensing is used to determine a location of one or more operational elements of the implement within the imaging region. The thermal sensor is used to determine a thermal characteristic (e.g. temperature) associated with each of the one or more operational elements. One or more systems of the agricultural machine may then be controlled in dependence on the determined thermal characteristic.

### TECHNICAL FIELD

The present invention relates, in general, to monitoring of implements associated with agricultural machines, and in particular to monitoring the operation of a header mounted or otherwise coupled to a harvesting machine.

### BACKGROUND

Agricultural machines including harvesting machines, e.g. combine harvesters and chopper-type forage harvesters generally include a header mounted forward of the machine and is configured to cut and collect crop material from a field for further processing by the harvester downstream of the header. Such headers typically include numerous different operational elements, including reel(s), cutter bar(s), cutter knives, conveyor(s), auger(s) and the like all working together to collect and pass cut crop onto a further processing arrangement of the machine.

As will be appreciated, each of the different operational elements must be monitored to ensure they are working correctly and/or as desired. Malfunction of any one of these elements may lead to downtime of the machine which may subsequently impact harvesting efficiency and may ultimately lead to loss in revenue for the operator. Many known systems rely on the operator of the machine to monitor the elements, in use. This results in an increased workload for the operator.

It would therefore be advantageous to provide an improved means for monitoring the operation of agricultural implements, for example to reduce the workload of an operator of an associated machine in monitoring such implements manually, and/or for monitoring implements where an operator is not present, e.g. for automated machines.

### SUMMARY OF THE INVENTION

In an aspect of the invention there is provided a system for monitoring the operation of an implement associated with an agricultural machine, the system comprising: a thermal sensor having a sensing region which at least partly covers the position of the implement; and one or more controllers configured to: receive sensor data from the thermal sensor; determine, from the sensor data received from the thermal sensor, a thermal characteristic associated with each of one or more operational elements of the implement; and output one or more control signals for controlling operation of one or more systems of the agricultural machine in dependence on the determined thermal characteristic.

In an aspect of the invention there is provided a system for monitoring the operation of an implement associated with an agricultural machine, the system comprising: an imaging sensor having an imaging region at least partly covering the implement; a thermal sensor having a sensing region which at least partly coincides with the imaging region of the imaging sensor; and one or more controllers configured to: receive sensor data from the imaging sensor and the thermal sensor; determine, from the sensor data received from the imaging sensor, a location of one or more operational elements of the implement within the imaging region; determine, from the sensor data received from the thermal sensor and in dependence on the respective location of the one or more operational elements, a thermal characteristic associated with each of the one or more operational elements; and output one or more control signals for controlling operation of one or more systems of the agricultural machine in dependence on the determined thermal characteristic.

Advantageously, the system of the present invention provides a means for associating a thermal characteristic observed using the thermal sensor with individual operational elements of the implement to monitor operation thereof. The thermal characteristic may be indicative of an operational state of the related element, and may indicate an issue with said element, e.g. where an increased temperature is observed.

The following features may apply to either of the above mentioned aspects of the invention.

The imaging sensor preferably comprises a camera. The imaging sensor may be mounted or otherwise coupled to the front of the agricultural machine. In embodiments, the imaging sensor is mounted or otherwise coupled to an operator cab of the agricultural machine, and captures sensor data of the environment forward of the agricultural machine, in use, for example covering the position of an implement mounted or otherwise coupled at the front of the agricultural machine.

The thermal sensor may comprise an infrared camera. The thermal sensor may be mounted or otherwise coupled to the front of the agricultural machine. In embodiments, the thermal sensor is mounted or otherwise coupled to an operator cab of the agricultural machine, and captures sensor data of the environment forward of the agricultural machine, in use, for example covering the position of an implement mounted or otherwise coupled at the front of the agricultural machine.

The imaging sensor and/or the thermal sensor may be mounted substantially centrally with respect to a lateral axis of the machine. Alternatively, one or both of the imaging sensor and thermal sensor may be positioned away from a central axis of the machine, for example one either side of the operator cab.

The thermal characteristic may comprise a temperature. The temperature may comprise an absolute temperature, or may comprise a relative temperature, for example relative to one or more further elements of the implement.

The implement is preferably a header for a harvesting machine, such as a header for a combine harvester or a forage harvester. The one or more operational elements of the implement may include one or more reels, cutter bars, conveyors, augers or the like.

The one or more controllers may be configured to map the sensor data received from the imaging sensor onto a measurement region at least partly covering the position of the implement in dependence on a known positional relationship between the imaging sensor and the measurement region. Likewise, the one or more controllers may be configured to map the sensor data received from the thermal sensor onto the measurement region in dependence on a known positional relationship between the thermal sensor and the measurement region. The one or more controllers may be configured to determine, from the sensor data received from the imaging sensor, a position of the one or more operational elements of the implement within the measurement region. The one or more controllers may be configured to determine the thermal characteristic, e.g. be configured to associate sensor data corresponding to a particular location within the measurement region, and further to particular operational element(s), in dependence on the determined position of the one or more operational elements.

The alignment of the imaging sensor and the thermal sensor may be determined through use of one or more markers visible to both sensors. This may include the use of one or more checkerboards or fiducial markers positioned at known locations, e.g. on the implement, such that the one or more controllers are operable to determine the position of the implement within the sensor data from each sensor.

In embodiments, the one or more controllers may comprise or may be communicably coupled to an image processing module for identifying operational elements of the implement within image data obtained by the imaging sensor. The image processing module may be configured to analyse, pixel-wise, the image data obtained by the imaging sensor to identify operational elements within the image data. This may include classifying each pixel based on a classifier, which may correspond to a value of the pixel (e.g. RGB/greyscale values, etc.). The classifier may be determined in dependence on a learned model trained on a set of training images of implements and operational elements thereof in a known position within the image data. The one or more controllers may be configured to update the classifier on receipt of additional image data from the imaging sensor. The one or more controllers may be configured to analyse the image data from the imaging sensor through a feature extraction process, analysing the image data to identify one or more features including boundaries or edges in the image data (e.g. a step in pixel value across multiple adjacent pixels), or certain shapes in the image data corresponding to an expected shape and size of individual operational elements of the implement within the image data.

In embodiments, the one or more systems of the agricultural machine controllable by the system of the present aspect may include a user interface, e.g. a display means, which may provide information, for example to an operator of the agricultural machine, of the determined thermal characteristic. This may comprise providing an audible or visual indicator to the operator of the determined thermal characteristic. For example, the user interface may be operable to or be instructed by the one or more controllers (e.g. through control signals output by the one or more controllers) to display or otherwise indicate an error state when the determined thermal characteristic differs from an expected level. For example, the one or more controllers may be configured to compare the determined thermal characteristic (e.g. a temperature) with a threshold and control the user interface in dependence on said comparison. This may, for example, advantageously provide a visual or audible indicator, e.g. to an operator of the machine, when an observed temperature exceeds a threshold temperature. This may include graphically illustrating the implement, and optionally identifying a particular operational element of the implement, associated with the determined thermal characteristic.

The threshold may be predetermined. In other embodiments, the threshold may comprise an average value of the thermal characteristic for a particular operational element in an operational mode, e.g. when not in an error state. This may be determined by the one or more controllers.

In embodiments, the system may be operable to control one or more operating parameters of the agricultural machine in dependence on the determined thermal characteristic. The one or more operating parameters may comprise a forward speed of the agricultural machine. This may include bringing the agricultural machine to a stop where an error state is identified, e.g. where the temperature of a given element is determined to exceed a threshold value. The one or more operating parameters may include an operating setting of one or more sub-assemblies of the agricultural machine, including an operating speed of the implement. Where the implement comprises a header for a harvesting machine, this may include reducing a reel speed or the like of the header.

The system may be configured to output, e.g. via the user interface, one or more indicators of suggested operating parameter settings to change the determined thermal characteristic, for example to prevent overworking of the implement or one or more operational elements thereof. This may include suggesting changing a forward speed of the machine, an operating setting of one or more sub-assemblies of the machine, and/or an operational setting of the implement itself.

The system may include one or more motion sensors. The one or more motions sensors may include one or more of: an accelerometer, a gyroscope, and an inertial measurement unit (IMU). The one or more motion sensors may be mounted or otherwise coupled to the implement. For example, the system may comprise one or more motion sensors mounted or otherwise coupled to a header for a harvesting machine, which may include motion sensor(s) mounted or otherwise coupled to operating element(s) of the header.

The one or more controllers may be configured to receive sensor data from the one or more motion sensors. The one or more controllers may be configured to determine, from the sensor data received from the motion sensor(s), a motion parameter associated with the implement and or one or more operating elements thereof. The motion parameter may comprise a measure of a vibration associated with the implement or operating element(s). The motion parameter may include a measure of a frequency and/or amplitude of a vibration associated with the implement or operating element(s). The motion parameter may include a measure of a rotational frequency or acceleration of one or more moveable operating elements of the implement

In another aspect of the invention there is provided a control system for monitoring the operation of an implement associated with an agricultural machine, the control system comprising one or more controllers, and being configured to: receive sensor data from a thermal sensor having a sensing region which at least partly covers the position of the implement; determine, from the sensor data received from the thermal sensor, a thermal characteristic associated with each of one or more operational elements of the implement; and output one or more control signals for controlling operation of one or more systems of the agricultural machine in dependence on the determined thermal characteristic.

In another aspect of the invention there is provided a control system for monitoring the operation of an implement associated with an agricultural machine, the control system comprising one or more controllers, and being configured to: receive image data from an imaging sensor having an imaging region at least partly covering the implement; receive sensor data from a thermal sensor having a sensing region which at least partly coincides with the imaging region of the imaging sensor; determine, from the sensor data received from the imaging sensor, a location of one or more operational elements of the implement within the imaging region; determine, from the sensor data received from the thermal sensor and in dependence on the respective location of the one or more operational elements, a thermal characteristic associated with each of the one or more operational elements; and output one or more control signals for controlling operation of one or more systems of the agricultural machine in dependence on the determined thermal characteristic.

The one or more controllers may collectively comprise an input (e.g. an electronic input) for receiving one or more input signals indicative of the image data and/or the sensor data. The one or more controllers may collectively comprise one or more processors (e.g. electronic processors) operable to execute computer readable instructions for controlling operation of the control system, for example to determine the location of the operational element(s) and/or to determine the thermal characteristic. The one or more processors may be operable to generate one or more control signals for controlling the one or more systems of the agricultural machine. The one or more controllers may collectively comprise an output (e.g. an electronic output) for outputting the one or more control signals.

The one or more controllers of the control system may be configured in any manner of the one or more controllers of the system described hereinabove with reference to the preceding aspects of the invention.

Another aspect of the invention provides an agricultural machine comprising the system and/or control system of any preceding aspect of the invention.

The agricultural machine may comprise a harvesting machine, such as a combine harvester or a forage harvester, for example. The implement may comprise a header for the harvesting machine, which may be mountable or otherwise coupleable to the harvesting machine.

A further aspect of the invention provides a method of monitoring the operation of an implement associated with an agricultural machine, the method comprising: receiving sensor data from a thermal sensor having a sensing region which at least partly covers the position of the implement; determining, from the sensor data received from the thermal sensor, a thermal characteristic associated with each of one or more operational elements of the implement; and controlling operation of one or more systems of the agricultural machine in dependence on the determined thermal characteristic.

In a further aspect of the invention there is provided a method of monitoring the operation of an implement associated with an agricultural machine, the method comprising: receiving image data from an imaging sensor having an imaging region at least partly covering the implement; receiving sensor data from a thermal sensor having a sensing region which at least partly coincides with the imaging region of the imaging sensor; determining, from the sensor data received from the imaging sensor, a location of one or more operational elements of the implement within the imaging region; determining, from the sensor data received from the thermal sensor and in dependence on the respective location of the one or more operational elements, a thermal characteristic associated with each of the one or more operational elements; and controlling operation of one or more systems of the agricultural machine in dependence on the determined thermal characteristic.

The following optional features may apply to either of the two preceding aspects as appropriate.

The thermal characteristic may comprise a temperature. The temperature may comprise an absolute temperature, or may comprise a relative temperature, for example relative to one or more further elements of the implement.

The method may comprise mapping the sensor data received from the imaging sensor onto a measurement region at least partly covering the position of the implement in dependence on a known positional relationship between the imaging sensor and the measurement region. Likewise, the method may comprise mapping the sensor data received from the thermal sensor onto the measurement region in dependence on a known positional relationship between the thermal sensor and the measurement region. The method may comprise determining, from the sensor data received from the imaging sensor, a position of the one or more operational elements of the implement within the measurement region. The method may comprise determining the thermal characteristic, e.g. be configured to associate sensor data corresponding to a particular location within the measurement region, and further to particular operational element(s), in dependence on the determined position of the one or more operational elements.

The alignment of the imaging sensor and the thermal sensor may be determined through use of one or more markers visible to both sensors. This may include the use of one or more checkerboards or fiducial markers positioned at known locations, e.g. on the implement, such that the position of the implement within the sensor data from each sensor may be determined.

In embodiments, the method may comprise identifying operational elements of the implement within image data obtained by the imaging sensor. This may comprise analysing, pixel-wise, the image data obtained by the imaging sensor to identify operational elements within the image data. This may include classifying each pixel based on a classifier, which may correspond to a value of the pixel (e.g. RGB/greyscale values, etc.). The classifier may be determined in dependence on a learned model trained on a set of training images of implements and operational elements thereof in a known position within the image data. The method may comprise updating the classifier on receipt of additional image data from the imaging sensor. The method may comprise analysing the image data from the imaging sensor through a feature extraction process, analysing the image data to identify one or more features including boundaries or edges in the image data (e.g. a step in pixel value across multiple adjacent pixels), or certain shapes in the image data corresponding to an expected shape and size of individual operational elements of the implement within the image data.

In embodiments, the one or more systems of the agricultural machine may include a user interface, e.g. a display means, which may provide information, for example to an operator of the agricultural machine, of the determined thermal characteristic. This may comprise providing an audible or visual indicator to the operator of the determined thermal characteristic. For example, the user interface may be used to display or otherwise indicate an error state when the determined thermal characteristic differs from an expected level. For example, the one or more controllers may be configured to compare the determined thermal characteristic (e.g. a temperature) with a threshold and control the user interface in dependence on said comparison. This may, for example, advantageously provide a visual or audible indicator, e.g. to an operator of the machine, when an observed temperature exceeds a threshold temperature. This may include graphically illustrating the implement, and optionally identifying a particular operational element of the implement, associated with the determined thermal characteristic.

The threshold may be predetermined. In other embodiments, the threshold may comprise an average value of the thermal characteristic for a particular operational element in an operational mode, e.g. when not in an error state. This may be determined by the one or more controllers.

In embodiments, the method may comprise controlling one or more operating parameters of the agricultural machine in dependence on the determined thermal characteristic. The one or more operating parameters may comprise a forward speed of the agricultural machine. This may include bringing the agricultural machine to a stop where an error state is identified, e.g. where the temperature of a given element is determined to exceed a threshold value. The one or more operating parameters may include an operating setting of one or more sub-assemblies of the agricultural machine, including an operating speed of the implement. Where the implement comprises a header for a harvesting machine, this may include reducing a reel speed or the like of the header.

The method may include outputting, e.g. via the user interface, one or more indicators of suggested operating parameter settings to change the determined thermal characteristic, for example to prevent overworking of the implement or one or more operational elements thereof. This may include suggesting changing a forward speed of the machine, an operating setting of one or more sub-assemblies of the machine, and/or an operational setting of the implement itself.

The method may include receiving sensor data from the one or more motion sensors. The one or more motions sensors may include one or more of: an accelerometer, a gyroscope, and an inertial measurement unit (IMU). The one or more motion sensors may be mounted or otherwise coupled to the implement. For example, one or more motion sensors may mounted or otherwise coupled to a header for a harvesting machine, which may include motion sensor(s) mounted or otherwise coupled to operating element(s) of the header. The method may include determining, from sensor data received from the motion sensor(s), a motion parameter associated with the implement and or one or more operating elements thereof. The motion parameter may comprise a measure of a vibration associated with the implement or operating element(s). The motion parameter may include a measure of a frequency and/or amplitude of a vibration associated with the implement or operating element(s). The motion parameter may include a measure of a rotational frequency or acceleration of one or more moveable operating elements of the implement.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments of the invention will now be described, by way of example only, with reference to the accompanying drawings, in which:

FIG. 1 schematically illustrates an agricultural machine embodying aspects of the present invention;

FIG. 2 is a plan schematic view of a harvesting header embodying aspects of the present invention;

FIG. 3 is a schematic diagram illustrating an embodiment of a control system in accordance with the invention;

FIG. 4 is a top down schematic view illustrating the agricultural machine of FIG. 1;

FIG. 5 is a top down schematic view illustrating a variant of the agricultural machine shown in FIG. 4;

FIG. 6 is a flowchart illustrating an embodiment of a method in accordance with the invention; and

FIGS. 7 & 8 are images obtained by a sensors forming part of aspects of the present invention.

### DETAILED DESCRIPTION

In general, the Figures illustrate an agricultural machine in the form of a combine harvester 10 and implement in the form of a header 12 coupled to the harvester 10 embodying aspects of the present invention.

The harvester 10 has the header 12 coupled in a known manner to a feederhouse 14 of the harvester 10. The harvester 10 also includes an operator cab 27, unloading auger 20 and a crop processing mechanism, indicated generally at 16, which is operable to separate grain and other crop material from the supporting plant matter. Various different configurations for the crop processing mechanism 16 are known, and will be apparent to the person skilled in the art so will not be described in detail herein. The invention is not limited in this sense.

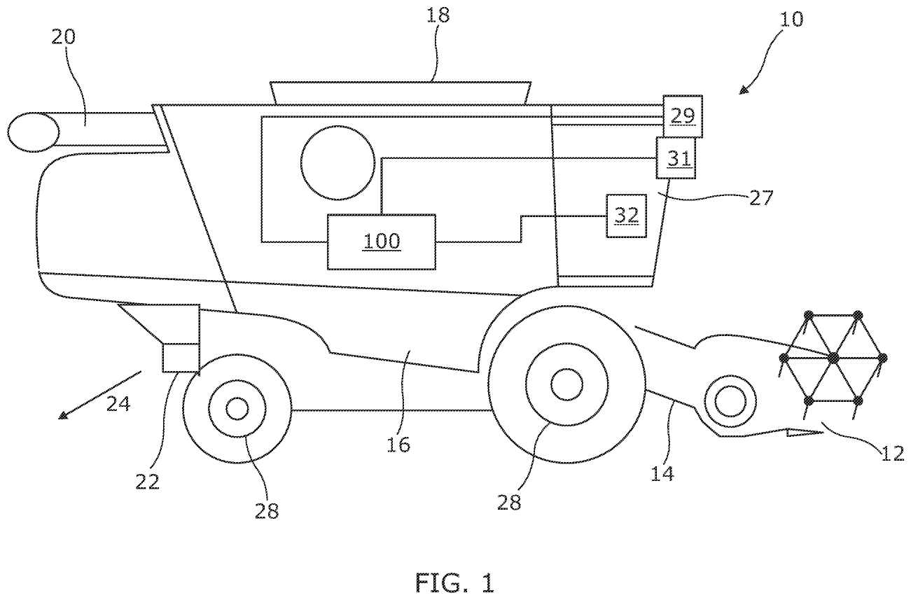

Clean grain separated from the cut crop material is collected in a grain bin 18, which may be periodically emptied, e.g. into a collection vehicle, storage container, etc. utilising unloading auger 20. The remaining non-grain material (MOG)/residue is separately moved to a spreader tool 22 which is operable in use to eject the non-grain material or MOG from the rear of the combine 10 and onto the ground. In FIG. 1, this is represented by arrow 24 which illustrates the MOG being ejected rearwards from the combine 10. It will be appreciated that in some embodiments the combine 10 may also include a chopper tool positioned, for example, between the crop processing apparatus 16 and the spreader tool 22 and operable, in use, to cut the MOG/residue before it is spread by the spreader tool 22.

The combine 10 also typically includes, amongst other features, wheels 28, engine (not shown) and a user interface 32.

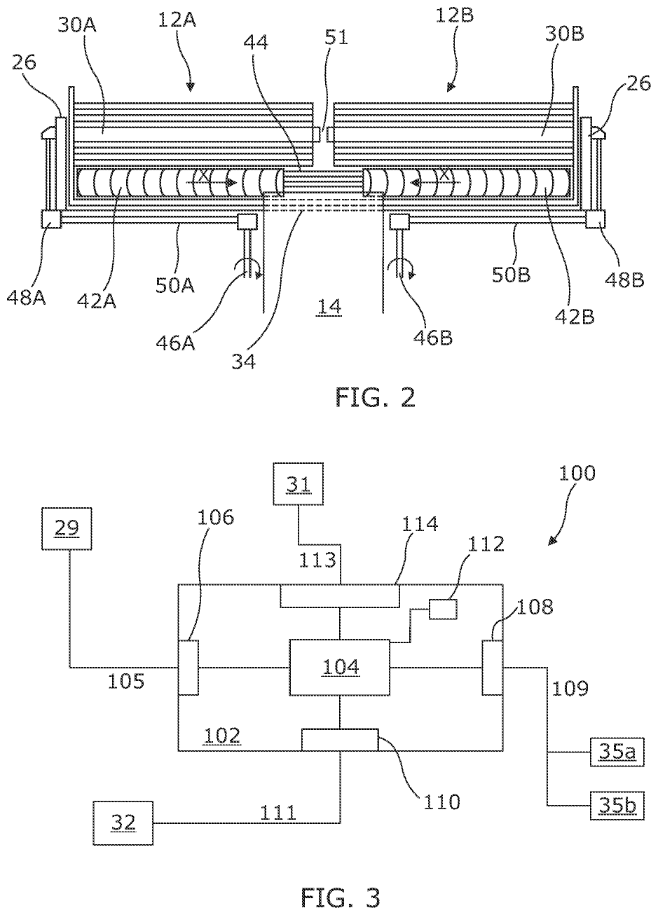

The header 12 has a frame comprising a table (alternatively termed a bed or floor) 22, a rear wall 24, two side walls 26 and a plurality of operational elements, as discussed herein. A standing crop such as cereals or maize is cut by a cutter bar 28 which is disposed on a leading edge of the table 22 as the harvester 10 advances in a forward direction across a crop field. A reel 30 is provided which guides the cut crop into the header 12. The reel 30 includes a plurality of guide bars 32, here six, which are mounted on (hexagonal) wheels which rotate around a transverse axis above the cutter bar 28. As particularly shown in FIG. 2, the illustrated header 12 comprises two crop gathering mechanisms or sub-assemblies (respectively identified by the suffixes A and B) 12A, 12B each having a respective reel 30A, 30B. Further, each sub-assembly 12A, 12B comprises respective draper belts 42A, 42B which are driven conveyors extending across the respective portions of table 22 and which convey the cut crop inwardly in the direction of arrows X towards an opening 34.

In the illustrated embodiment in FIG. 2, the header 12 includes a further belt 44 in a central section between the sub-assemblies 12A, 12B. This further belt 44 operates transversely to the draper belts 42A, 42B (having received cut crop deposited by the draper belts) and carries the cut crop through the opening 34 and into the feederhouse 14 for onward handling by the crop processing mechanism 20.

Here, the crop gathering mechanisms (reels 30 and draper belt 42 or auger 36) of one header sub-assembly are operable independently of the (or each) other. As described in further detail herein, the operation of each sub-assembly 12A, 12B and in particular individual operational elements thereof may be monitored using thermal and/or imaging sensors.

In the embodiment of FIG. 2, mechanical drive is provided for respective sub-assembles 12A, 12B by two separate (and independently driven) driveshafts 46A, 46B extending from the harvester 10 (suitably supported along respective sides of the feeder housing 14) to the header 12. Via one or more universal joints 48A, 48B and intermediate driveshafts 50A, 50B, the rotation of the driveshafts is transferred to drive rotation of the respective reels 30A, 30B. Further driveshafts (or driven spurs off the driveline to the reels) suitably power the draper belts 42A, 42B. The drive to the crop gathering components 30, 36, 42 may suitably be supplied at the laterally outermost points of each sub-assembly as shown, with a central support, indicated generally at 51, supporting and journaling the inward end of the crop gathering components. Providing drive to the inward ends of the components, with support at the outward ends, is also possible.

As an alternative to mechanical drive, one or more of the crop gathering components may be provided with electric drive through one or more electric motors mounted on the header and driving the components directly. This arrangement is preferred where there are e.g. four or more sub-assemblies as the control connections become simpler than having multiple mechanical drive shafts, and the (generally shorter) header sections and sub-assemblies will require less power to drive.

As will be discussed in detail herein, the combine 10 additionally includes a pair of sensors for monitoring operation of the header 12 and individual operational elements thereof. The sensors include an imaging sensor in the form of a camera 31 and a thermal sensor in the form of an infrared thermal camera 29. Both the camera 31 and the infrared thermal camera 29 are mounted at the front of the combine 10 above the operator cab 27, having respective sensing regions forwards of the combine 10 and covering the area in which the header 12 is positioned. The camera 31 and thermal imaging camera 29 are used, by a control system 100 of the combine 10, to determine a thermal characteristic associated with one or more operational elements of the header 12. As discussed herein, individual operational elements may include the cutter bar 28, reels 30A, 30B, belts 42A, 42B, 44 and the like. The thermal characteristic determined is indicative of the operation of the individual elements.

FIG. 3 illustrates the control system 100 further. As shown, control system 100 comprises a controller 102 having an electronic processor 104, electronic inputs 106, 108, 113 and an electronic output 110. The processor 104 is operable to access a memory 112 of the controller 102 and execute instructions stored therein to perform the steps and functionality of the present invention discussed herein, e.g. by controlling the user interface 32, to indicate, e.g. to an operator of the combine 10, information indicative of the determined thermal characteristic(s).

The processor 104 is operable to receive sensor data via input 106 which, in the illustrated embodiment, takes the form of input signals 105 received from the thermal imagine camera 29. Utilising this data, the processor 104 is configured to analyse the data and determine therefrom a measure of a thermal characteristic e.g. a temperature, associated with one or more individual operational elements of the header 12. As discussed above, the determined thermal characteristic, or a notification indicative thereof can be presented to an operator of the combine 10 via the user interface 32.

In order to position operational elements of the header 12 within the sensor data received from the thermal camera 29, camera 21 is used. Specifically, the processor 104 is operable to receive sensor data via input 114 which, in the illustrated embodiment, takes the form of input signals 113 received from the camera 31. The processor 104 is operable to determine, from the sensor data, the relative positions of individual operational elements of the header 12 within the data. As is described herein, this may include analysing the image data using a feature extraction process, looking for specific shapes, contours or the like in the image data to identify individual elements therefrom. Utilising this positional information, and with knowledge of the respective positions of the thermal imaging camera 29 and the camera 31, individual operational elements may also be identified in the sensor data from the thermal imaging camera 29, and thermal characteristics at locations within the sensor data may thereby be associated with specific elements by the processor 104.

Output 110 is operably coupled to the user interface 32 of the combine 10. Here, the control system 100 is operable to control operation of the user interface 32, e.g. through output of control signals 111 in order to display data to an operator of the combine 10 relating to the operation of the control system 100. Specifically, the control system 100 is operable to control the user interface to display to the operator an indicator of the determined thermal characteristic.

FIG. 3 additionally illustrates a further feature of the control system 100, and a variant of the present invention. Specifically, controller 102 includes an electronic input 108 configured to receive sensor data, here in the form of input signals 109, from multiple motion sensors—here in the form of an accelerometer 35a and a gyroscope 35b. The processor 104 is configured to determine a measure of a vibration associated with the header 12 and/or individual operating elements thereof. The motion parameter may include a measure of a frequency and/or amplitude of a vibration associated with the header 12 or operating element(s) and can be used in conjunction with the thermal characteristic to determine an operational state of the header 12. For example, a significant vibration for the header 12 or elements thereof may indicate a malfunctioning component. This may be confirmed if the thermal characteristic associated with the header 12 indicates an increased temperature.

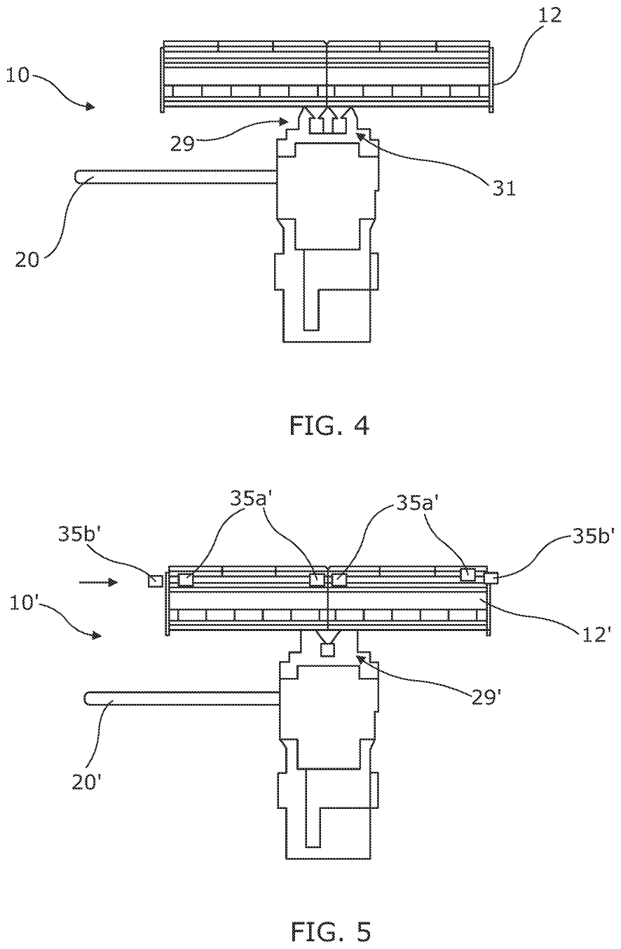

FIGS. 4 & 5 are top down schematic views of two separate embodiments of the combine 10, specifically showing the respective locations of various sensors forming part of aspects of the invention. In FIG. 4, the combine 10 comprises a camera 31 and a thermal imaging camera 29 mounted substantially centrally on the operator cab of the combine 10, directed over the header 12. In FIG. 5, the camera 31 is replaced by motion sensors in the form of four accelerometers 35a′ and two gyroscopes 35b′. As shown, the accelerometers 35a′ are positioned along the width of the header 12′ and are configured to monitor vibrations of the individual elements of the header 12′, including in the illustrated embodiment vibrations associated with reels of the header 12′. Gyroscopes 35b′ are positioned at either end of the header 12′ and are configured to monitor any vibration/rotation in the header 12 as a whole. As discussed herein, data from the motion sensors may be used in conjunction with the determined thermal characteristic to monitor operation of the header 12′.

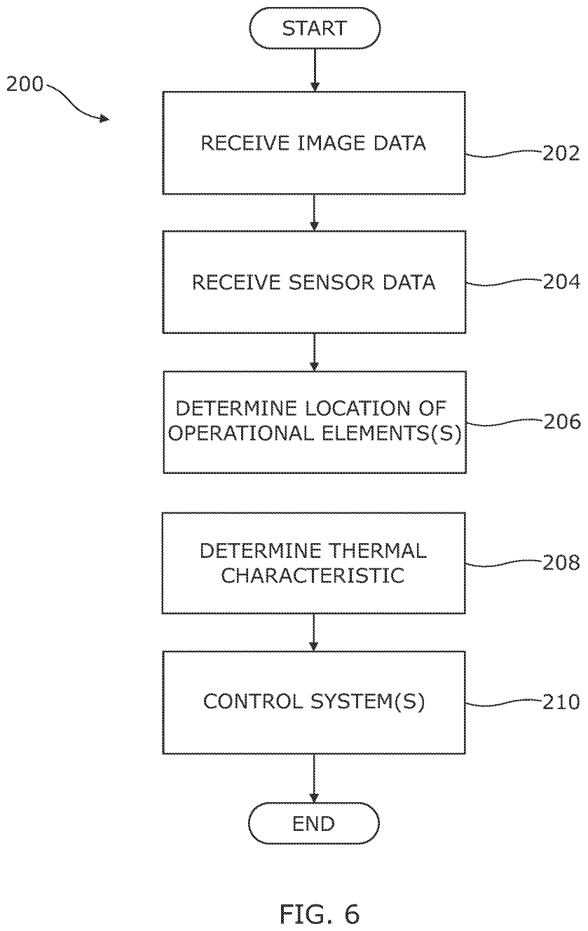

FIG. 6 illustrates a method 200 in accordance with the invention.

At step 202, image data is received from the camera 31. As discussed herein, the camera 31 has an imaging region (otherwise referred to as a field of view) which encompasses the position of header 12. At step 204, sensor data is received from thermal imaging camera 29. The sensing region of the thermal imaging camera 29 and camera 31 overlap in such a manner that they both cover the location of the header 12.

At step 206, the location of individual operational elements of the header 12 are determined from the image data received from the camera 31. As discussed herein, this may involve various image analysis processes, including feature extraction, boundary identification and the like to determine the location of each element from the images obtained. With knowledge of the respective positions of the camera 31 and thermal sensor 29, the positions of the individual operating elements can also be identified in the sensor data received from the thermal sensor 29.

At step 208, the sensor data from the thermal sensor 31 is analysed further to extract a thermal characteristic for each of the identified operational elements. This includes determining an operating temperature of each element. This is compared with a threshold temperature to determine/identify whether there is a component malfunction for the header 12. As discussed herein, the threshold may be predetermined or may be an average operating temperature as determined through monitoring of the header 12 over a period of time, e.g. using the thermal imaging sensor 31.

Where the determined temperature for each element is determined to be within an expected temperature range for the header 12, no further action may be taken and the method may return to step 202. However, where the temperature of a given element is determined to lie outside of an expected operating temperature range, e.g. because the temperature is above the threshold temperature then a warning may be issued to an operator of the combine 10 at step 210. As discussed herein, this may take the form of issuance of a notification to the operator using the user interface 32 of the combine 10. In further embodiments, the engine and/or braking system of the combine 10 may be actively controlled to reduce the combine speed, or to bring the combine 10 to a stop to prevent further malfunction/damage. In further embodiments, operation of the header 12 may be controlled, e.g. by stopping rotation of one or more reels of the header 12, or conveyors or augers of the header 12, for example, again to prevent further malfunction and/or damage.

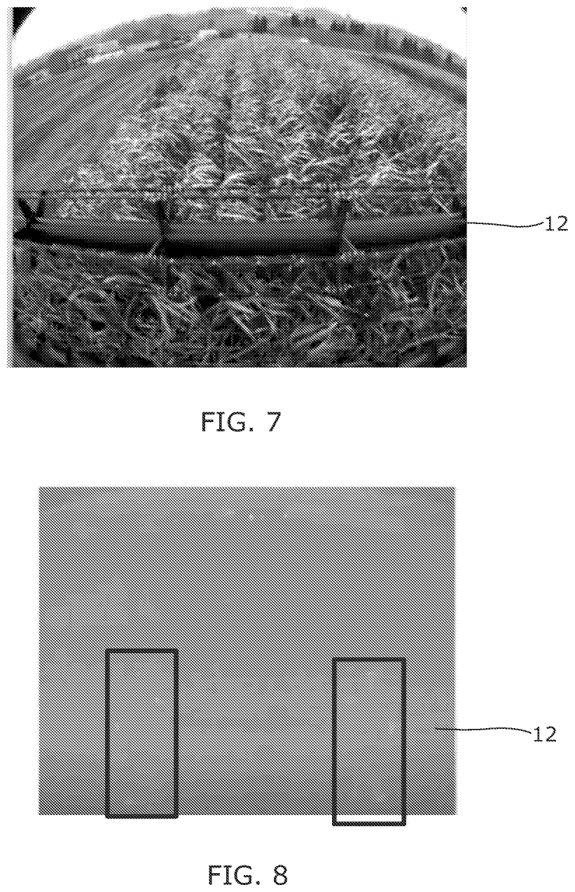

FIGS. 7 and 8 illustrate images obtained by a camera 31 (FIG. 7) and a thermal imaging camera 29 (FIG. 8), illustrating the operational use of aspects of the present invention. As shown in FIG. 7, the camera 31 obtains an image forward of the combine 10 during a harvesting operation in a field. In the image, the header 12, and individual elements thereof, can be identified and positioned (in the manner discussed herein). FIG. 8 illustrates an equivalent image obtained by thermal imaging sensor 29. Here, a thermal characteristic for each element can be determined, and is illustrated by the boxed regions in FIG. 8 showing areas of increased temperature. As discussed herein, the temperature determined from the thermal imaging sensor data is compared with a threshold to determine whether the associated implement element is operating correctly, or whether excess heat is being generated which may be indicative of a fault. If a fault is determined, the user interface 32 of the combine 10 is controlled to display this information to a user, in the manner discussed herein.

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as set out herein and a machine readable storage storing such a program. Still further, embodiments of the present invention may be conveyed electronically via any medium such as a communication signal carried over a wired or wireless connection and embodiments suitably encompass the same.

It will be appreciated that the above embodiments are discussed by way of example only. Various changes and modifications can be made without departing from the scope of the present application.

1. A system for monitoring the operation of an implement associated with an agricultural machine, the system comprising:
an imaging sensor having an imaging region at least partly covering the implement;
a thermal sensor having a sensing region which at least partly coincides with the imaging region of the imaging sensor; and
one or more controllers configured to:
receive sensor data from the imaging sensor and the thermal sensor;
determine, from the sensor data received from the imaging sensor, a location of one or more operational elements of the implement within the imaging region;
determine, from the sensor data received from the thermal sensor and in dependence on the respective location of the one or more operational elements, a thermal characteristic associated with each of the one or more operational elements; and
output one or more control signals for controlling operation of one or more systems of the agricultural machine in dependence on the determined thermal characteristic.

2. The system of claim 1, wherein the imaging sensor comprises a camera mounted or otherwise coupled to the front of the agricultural machine; and the thermal sensor comprises an infrared camera mounted or otherwise coupled to the front of the agricultural machine.

3. The system of claim 1, wherein the thermal characteristic comprises a temperature.

4. The system of claim 1, wherein the one or more controllers are configured to determine an alignment of the imaging sensor and the thermal sensor through use of one or more markers visible to both sensors.

5. The system of claim 1, wherein the one or more systems of the agricultural machine controllable include a user interface, which provides information of the determined thermal characteristic.

6. The system of claim 5, wherein the user interface is operable to or be instructed by the one or more controllers to display or otherwise indicate an error state when the determined thermal characteristic differs from an expected level.

7. The system of claim 6, wherein the one or more controllers are be configured to compare the determined thermal characteristic with a threshold and control the user interface in dependence on said comparison.

8. The system of claim 7, wherein threshold is predetermined; or wherein the threshold comprises an average value of the thermal characteristic for a particular operational element in an operational mode.

9. The system of claim 1, wherein the one or more controllers are operable to control one or more operating parameters of the agricultural machine in dependence on the determined thermal characteristic.

10. The system of claim 9, wherein the one or more operating parameters comprises a forward speed of the agricultural machine.

11. The system of claim 9, wherein the one or more operating parameters include an operating setting of one or more sub-assemblies of the agricultural machine, including an operating speed of the implement.

12. The system of claim 11, wherein the implement comprises a header for a harvesting machine, and the one or more controllers are operable to control a reel speed of the header.

13. The system of claim 1, wherein the one or more controllers are configured to control output of one or more indicators of suggested operating parameter settings to change the determined thermal characteristic.

14. The system of claim 1, comprising one or more motion sensors; and
wherein the one or more controllers are configured to:
receive sensor data from the one or more motion sensors; and
determine therefrom a motion parameter associated with the implement and/or one or more operating elements thereof.

15. The system of claim 14, wherein the motion parameter comprises a measure of a frequency and/or amplitude of a vibration associated with the implement and/or one or more operating elements thereof; and/or or a measure of a rotational frequency or acceleration of one or more moveable operating elements of the implement.

16. A control system for monitoring the operation of an implement associated with an agricultural machine, the control system comprising one or more controllers, and being configured to:
receive image data from an imaging sensor having an imaging region at least partly covering the implement;
receive sensor data from a thermal sensor having a sensing region which at least partly coincides with the imaging region of the imaging sensor;
determine, from the sensor data received from the imaging sensor, a location of one or more operational elements of the implement within the imaging region;
determine, from the sensor data received from the thermal sensor and in dependence on the respective location of the one or more operational elements, a thermal characteristic associated with each of the one or more operational elements; and
output one or more control signals for controlling operation of one or more systems of the agricultural machine in dependence on the determined thermal characteristic.

17. An agricultural machine comprising the system of claim 1.

18. A method of monitoring the operation of an implement associated with an agricultural machine, the method comprising:
receiving image data from an imaging sensor having an imaging region at least partly covering the implement;
receiving sensor data from a thermal sensor having a sensing region which at least partly coincides with the imaging region of the imaging sensor;
determining, from the sensor data received from the imaging sensor, a location of one or more operational elements of the implement within the imaging region;
determining, from the sensor data received from the thermal sensor and in dependence on the respective location of the one or more operational elements, a thermal characteristic associated with each of the one or more operational elements; and
controlling operation of one or more systems of the agricultural machine in dependence on the determined thermal characteristic.
